(19) United States
(12) Patent Application Publication
(10) Pub. No.: US 2020/0256292 A1
(43) Pub. Date: Aug. 13, 2020

(54) INTAKE AIR INCREASING DEVICE

(71) Applicant: ISUZU MOTORS LIMITED, Shinagawa-ku, Tokyo (JP)

(72) Inventors: Ryusuke FUJINO, Chigasaki-shi, Kanagawa (JP); Naoya ISHIKAWA, Yokohama-shi, Kanagawa (JP)

(21) Appl. No.: 16/500,342

(22) PCT Filed: Mar. 27, 2018
(86) PCT No.: PCT/JP2018/012351

§ 371 Date: Oct. 2, 2019

(30) Foreign Application Priority Data
Apr. 4, 2017 (JP) 2017-074595

(51) Int. Cl. F02M 35/10; F02D 45/00

(52) U.S. Cl. CPC F02M 35/10163; F02M 35/164; F02D 45/00

(57) ABSTRACT

The intake increasing device 100 pertaining to the present invention is for increasing air intake of an engine, and is provided with, a cylindrical wall part 20 having an intake inlet 20in and an intake outlet 20out, the wall part 20 leading intake air from the intake air inlet 20in to the intake air outlet 20out, an ejection port 30 for ejecting air F2 flowing along an inner circumferential surface 21 of the wall portion 20 to an air intake downstream side, the ejection port 30 being provided in the wall part 20; and a fan 40 for sending air to the ejection port 30.

### TECHNICAL FIELD

The present disclosure relates to an intake increasing device for an engine.

### BACKGROUND ART

In general, in an engine mounted on a vehicle or the like, an amount of intake air required for combustion is introduced into the combustion chamber according to a required output. In addition, a large amount of intake air can be fed into the combustion chamber by using a supercharger or the like to increase the output.

### CITATION LIST

### Patent Literature

Patent Literature 1: JP-A-2007-138899

### SUMMARY OF INVENTION

### Technical Problem

However, for example, in places where the atmospheric pressure is low, such as high altitudes, since the oxygen concentration in the air is low, it may not be possible to ensure a required amount of intake air even when a supercharger or the like is used. In this case, the engine output is reduced and the fuel efficiency deteriorates.

In particular, in an operating state in which an engine speed is low, the supercharger or the like may not operate efficiently. For this reason, for example, when the vehicle starts, the engine output may be reduced, and the startability may deteriorate.

Therefore, in order to solve the above-mentioned problems, an object of the present disclosure is to provide an intake increasing device capable of ensuring a required amount of intake air and suppressing output reduction regardless of an operating environment and an operating state of an engine.

### Solution to Problem

According to one aspect of the present disclosure, there is provided an intake increasing device for increasing intake of an engine, which includes a cylindrical wall part which includes an intake inlet and an intake outlet and guides intake air from the intake inlet to the intake outlet, a ejection port for ejecting air flowing toward an intake downstream side along an inner circumferential surface of the wall portion, and a fan for sending air to the ejection port.

A cross-sectional shape of the inner circumferential surface of the wall portion preferably approximates to a cross-sectional shape of a blade upper surface.

Preferably, the inner circumferential surface of the wall portion includes a reduced diameter portion which is gradually reduced in diameter in a round cross-sectional shape from the intake inlet, and an enlarged diameter portion which smoothly connects to the reduced diameter portion and is gradually enlarged, and the ejection port is positioned on the reduced diameter portion and is directed toward the intake downstream side.

The ejection port preferably extends in a peripheral direction of the wall portion.

It is preferable that the engine is mounted on a vehicle and the intake increasing device further includes a control unit for controlling the fan and an accelerator opening sensor for detecting an accelerator opening, in which the control unit operates the fan when the first condition that the detection value of the accelerator opening sensor is larger than the first threshold value is satisfied.

It is preferable that the intake increasing device further includes an atmospheric pressure sensor for detecting atmospheric pressure and an engine rotation sensor for detecting the engine speed, in which the control unit operates the fan when the first condition is satisfied and at least one of a second condition in which a detection value of the atmospheric pressure sensor is equal to or less than a second threshold value and a third condition that the detection value of the engine rotation sensor is equal to or less than a third threshold value is satisfied.

It is preferable that the engine includes a supercharger, the intake increasing device further includes an atmospheric pressure sensor for detecting atmospheric pressure, an engine rotation sensor for detecting the engine speed, and a supercharging pressure sensor for detecting the supercharging pressure, in which the control unit operates the fan when the first condition is satisfied and at least one of the second condition in which a detection value of the atmospheric pressure sensor is equal to or less than the second threshold value and a fourth condition that the engine operating state defined based on a detection value of the engine rotation sensor and a detection value of the supercharging pressure sensor is in a predetermined supercharging insufficient state is satisfied.

It is preferable that the engine is mounted on a vehicle including a cab, and the wall portion is formed in a flat cross section, and is disposed along a rear surface of the cab such that the intake inlet opens upward, the intake outlet opens downward, and the longitudinal direction of the cross section thereof coincides with the vehicle width direction.

It is preferable that the engine includes an air cleaner and an intake duct connected to an inlet portion of the air cleaner, and the wall portion is connected to an inlet portion of the intake duct, the inlet portion of the intake duct is formed in a flat cross section, and the intake outlet is connected to an inlet of the intake duct.

### Advantageous Effects of Invention

According to the present disclosure, an intake increasing device can be provided which is capable of ensuring a required amount of intake air and suppressing output reduction regardless of the use environment and the operating state of the engine.

### BRIEF DESCRIPTION OF DRAWINGS

FIG. 1 is a schematic configuration view showing a vehicle to which an intake increasing device according to a first embodiment is applied.

FIG. 2 is a schematic perspective view of the intake increasing device in FIG. 1.

FIG. 3 is a cross-sectional view taken along line III-III in FIG. 2.

FIG. 4 is a cross-sectional view taken along line IV-IV in FIG. 2.

FIG. 5 is an enlarged view of a portion V in FIG. 4.

FIG. 6 is a view showing a control flow in the first embodiment.

FIG. 7 is a schematic perspective view showing an overall configuration of an intake increasing device according to a second embodiment.

FIG. 8 is a cross-sectional view taken along line VIII-VIII in FIG. 7.

FIG. 9 is a cross-sectional view taken along line IX-IX in FIG. 8.

FIG. 10 is a view showing a control flow in a third embodiment.

FIG. 11 is a map showing a relationship between an engine speed and a supercharging pressure in the third embodiment.

### DESCRIPTION OF EMBODIMENTS

Embodiments of the present disclosure will be described below with reference to the accompanying drawings. Although directions shown in the drawings are merely defined for convenience of description, the directions are assumed to coincide with the respective directions of the vehicle.

### (1) First Embodiment

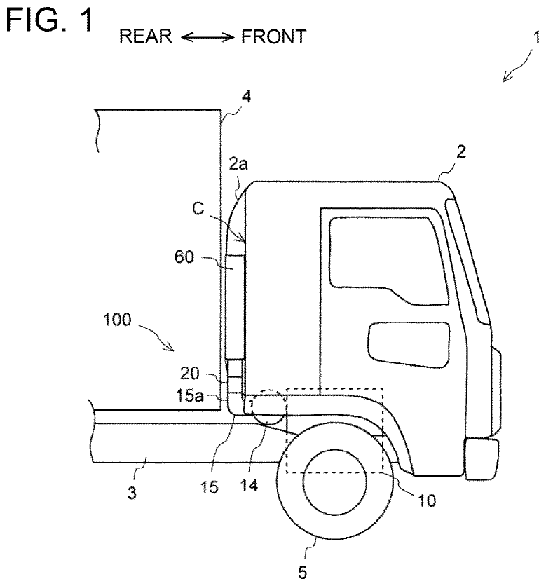

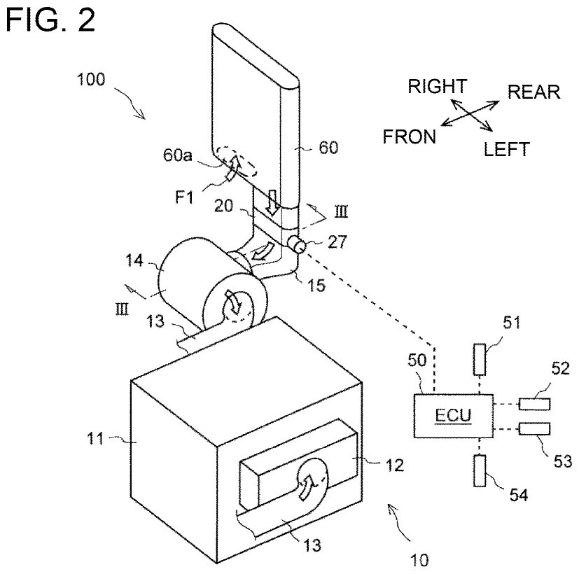

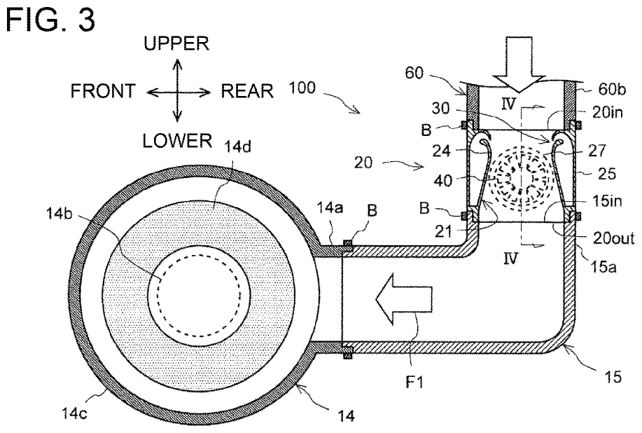

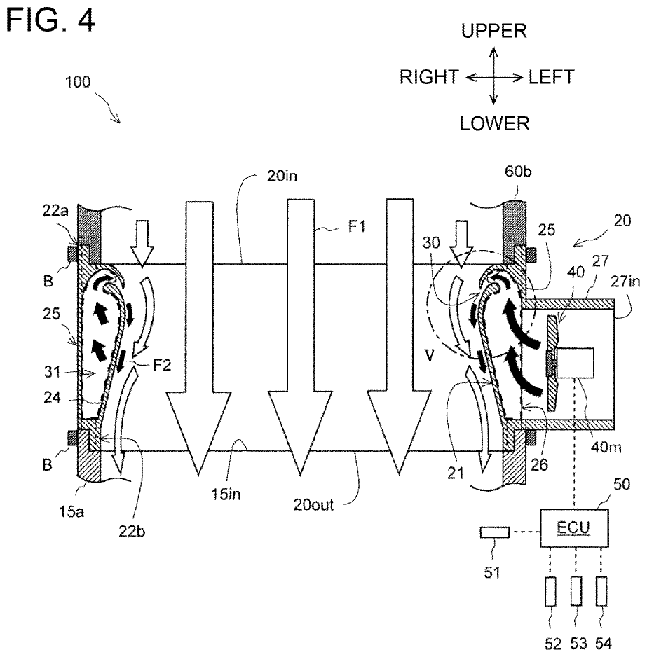

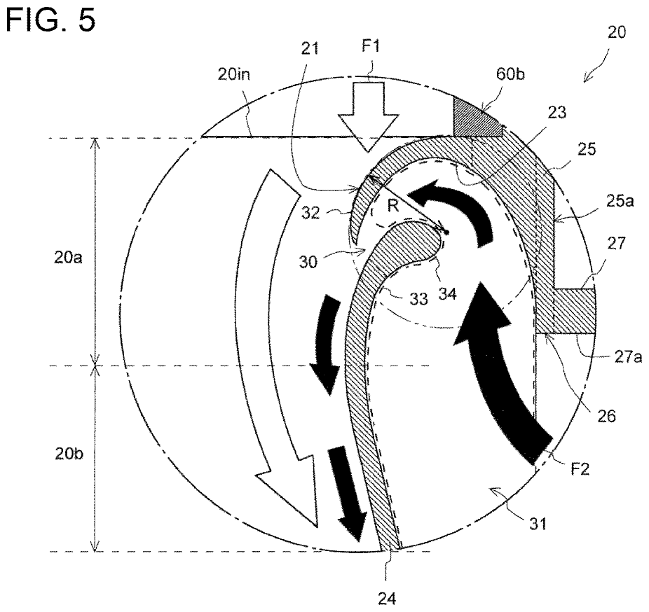

FIG. 1 is a schematic configuration view showing a vehicle 1 to which an intake increasing device 100 according to a first embodiment of the present disclosure is applied. Further, FIG. 2 is a schematic perspective view showing an overall configuration of the intake increasing device 100, and FIG. 3 is a cross-sectional view taken along line III-III in FIG. 2. Further, FIG. 4 is a cross-sectional view taken along line IV-IV in FIG. 3, and FIG. 5 is an enlarged view of a portion V in FIG. 4. A white arrow F1 shown in FIGS. 2 to 5 represents intake air. A black arrow F2 shown in FIGS. 4 and 5 represents the air (described later) ejected from an ejection port 30.

As shown in FIGS. 1 and 2, the intake increasing device 100 is an intake increasing device for increasing the intake air F1 of the engine 10. As shown in FIGS. 3 to 5, the intake increasing device 100 includes a tubular body 20 including an intake inlet 20in and an intake outlet 20out and leading the intake air F1 from the intake inlet 20in to the intake outlet 20out. The intake increasing device 100 includes a ejection port 30 which is provided in the tubular body 20 and ejects air F2 flowing toward the intake downstream side along an inner circumferential surface 21 of the tubular body 20, and a fan 40 for sending the air F2 to the ejection port 30. Further, the intake increasing device 100 includes an electronic control unit (ECU) 50 as a control unit for controlling the fan 40.

The intake increasing device 100 further includes an accelerator opening sensor 51 for detecting an accelerator opening. The intake increasing device 100 further includes an atmospheric pressure sensor 52 for detecting an atmospheric pressure and an engine rotation sensor 53 for detecting the engine speed. The intake increasing device 100 further includes an supercharging pressure sensor 54 for detecting the supercharging pressure. However, in the present embodiment, the supercharging pressure sensor 54 may be optional.

Specifically, as shown in FIG. 1, the engine 10 is a multi-cylinder compression-ignition internal combustion engine mounted on the vehicle 1, that is, a diesel engine. However, the type, the form, the number of cylinders, and the like of the engine 10 are optional.

The vehicle 1 is a cab-over type truck, and includes a cab 2, an engine 10 disposed in a lower portion of the cab 2, a chassis frame 3 for supporting the cab 2, and a bodywork 4 disposed at the rear of the cab 2. Reference numeral 5 denotes a front wheel of the vehicle 1.

As shown in FIG. 2, the engine 10 includes an engine body 11 including a plurality of combustion chambers (not shown), an intake manifold 12 for distributing intake air F1 into each combustion chamber, and an intake pipe 13 connected to an upstream end of the intake manifold 12. In addition, the engine 10 includes a turbocharger (not shown) as a supercharger. A turbocharger compressor (not shown) is provided in the middle of the intake pipe 13.

As shown in FIGS. 2 and 3, the engine 10 includes an air cleaner 14 and an intake duct 15 connected to an inlet portion 14a of the air cleaner 14. The outlet portion 14b of the air cleaner 14 is connected to an upstream end of the intake pipe 13. These connecting portions are connected to each other by a spigot joint fitting, and are fixed to each other by a metal band B. However, the connection method may be any method.

The air cleaner 14 includes a case 14c having the inlet portion 14a and the outlet portion 14b, and a cylindrical air filter 14d accommodated in the case 14c. However, the air filter 14d may be of any type. The air cleaner 14 is disposed on the right rear side of the engine body 11, and the inlet portion 14a is opened rearward.

As shown in FIGS. 1 to 3, the intake duct 15 extends rearward from the inlet portion 14a of the air cleaner 14 and is bent upward at a position of a lower end of the rear surface 2a of the cab 2. An inlet portion 15a of the intake duct 15 is formed in a flat cross section, opens upward, and is disposed such that the longitudinal direction of the cross section thereof coincides with the vehicle width direction (the left-right direction in the drawing).

The tubular body 20 is connected to the inlet portion 15a of the intake duct 15. More specifically, the tubular body 20 is formed in a flat cross section and is disposed along the rear surface 2a of the cab 2 such that the intake inlet 20in opens upward, the intake outlet 20out opens downward, and the longitudinal direction of the cross section of thereof coincides with the vehicle width direction.

The intake outlet 20out is connected to an inlet 15in of the intake duct 15. A cover member 60 for preventing foreign substances from entering from above is connected to the intake inlet 20in.

The cover member 60 includes an inlet portion 60a as an inlet and an outlet portion 60b connected to an upstream end portion of the tubular body 20. The cover member 60 is formed in a flat cross section and extends upward from the outlet portion 60b and extends rightward along the rear surface 2a of the cab 2. The inlet portion 60a is opened downward at the bottom portion of the extended portion.

As shown in FIG. 1, the rear surface 2a of the cab 2 may be provided with a recessed portion C at left and right positions thereof. The tubular body 20 and the cover member 60 may be disposed so as to fit in the recessed portions C.

Next, the configurations of the tubular body 20, the ejection port 30, and the fan 40 will be described in detail with reference to FIGS. 4 and 5.

As shown in FIGS. 4 and 5, in the flow direction of the intake air F1, the intake inlet 20in is positioned at the upstream end of the tubular body 20, and the intake outlet 20out is positioned at the downstream end of the tubular body 20.

The tubular body 20 includes an upstream spigot fitting portion 22a formed over the entire periphery at an upstream end portion thereof, and a downstream spigot fitting portion 22b formed over the entire periphery at the downstream end portion thereof in the flow direction of the intake air F1. The upstream spigot fitting portion 22a is connected to the outlet portion 60b of the cover member 60 by spigot fitting, and the upstream spigot fitting portion 22a and the outlet portion 60b are fixed to each other by the metal band B. The downstream spigot fitting portion 22b is connected to the inlet portion 15a of the intake duct 15 by spigot fitting, and the downstream spigot fitting portion 22b and the inlet portion 15a are fixed to each other by the metal band B. However, these connection methods may be any method.

The inner circumferential surface 21 of the tubular body 20 has a cross-sectional shape approximating the cross-sectional shape of the blade upper surface. Specifically, the inner circumferential surface 21 of the tubular body 20 includes a reduced diameter portion 20a gradually reduced in diameter from the intake inlet 20in to a round cross-sectional shape, and an enlarged diameter portion 20b smoothly connected to the reduced diameter portion 20a and gradually enlarged in diameter. The ejection port 30 is positioned in the reduced diameter portion 20a and is directed toward the intake downstream side. The ejection port 30 extends in the peripheral direction of the tubular body 20, and extends over the entire periphery.

More specifically, the reduced diameter portion 20a is reduced in diameter so as to expand radially inward from the intake inlet 20in in the flow direction of the intake air F1. The reduced diameter portion 20a is reduced in diameter from the intake inlet 20in to the ejection port 30 in a round cross-sectional shape having a predetermined radius of curvature R. On the other hand, the enlarged diameter portion 20b is enlarged in diameter so as to extend in a round or straight line up to the downstream end of the tubular body 20 in the flow direction of the intake air F1. The connection portion between the reduced diameter portion 20a and the enlarged diameter portion 20b is formed in a round cross-sectional shape.

A space 31 (not shown) that extends from the upstream end to the downstream end and communicates with the ejection port 30 at the position of the reduced diameter portion 20a is formed inside the tubular body 20. The space 31 is formed over the entire periphery of the tubular body 20. A curved surface portion 23 having a round cross-sectional shape facing the space 31 is formed at an upstream end portion of the tubular body 20. Further, the tubular body 20 includes an inner wall portion 24 defined radially inward and an outer wall portion 25 defined radially outward with the space 31 in between.

The ejection port 30 is formed by cutting the inner wall portion 24 over the entire periphery, and is formed in a slit shape by an upstream side cutting end portion 32 and a downstream side cutting end portion 33. The upstream side cutting end portion 32 is formed to be sharp toward the intake downstream side. On the other hand, the downstream side cutting end portion 33 is bent or curved so as to be positioned radially outward with respect to the upstream side cutting end portion 32.

The downstream side cutting end portion 33 includes a tongue piece portion 34 that is curved in a tongue-like shape. A tip end portion of the tongue piece portion 34 is formed in a round cross-sectional shape. However, the shape of the tip end portion of the tongue piece portion 34 is optional, and may be formed in a sharp shape, for example.

The tongue piece portion 34 is disposed so as to overlap with the upstream side cutting end portion 32 and guides the air F2 from the space 31 to the ejection port 30. In addition, in the flow direction of the air F2, the tongue piece portion 34 is disposed such that a distance from the upstream side cutting end portion 32 is gradually reduced, and is formed such that the ejection port 30 is in a nozzle shape.

The outer wall potion 25 includes an outer peripheral surface 25a extending linearly from the upstream end portion to the downstream end portion in the flow direction of the intake air F1. The outer wall portion 25 includes a circular opening portion 26 on the left side surface. The outer wall portion 25 is provided with a tubular fan attachment portion 27 protruding leftward from the opening portion 26.

The fan attachment portion 27 includes an air inlet 27in at a left end portion for taking in outside air. A fan cover (not shown) capable of passing outside air is attached to the air inlet 27in.

The fan 40 includes an axial flow fan and includes a motor 40m as a power source. The fan 40 is disposed coaxially within the fan attachment portion 27 and is disposed so as to eject the air F2 toward the space 31. The type of the fan is optional, and may be, for example, a mixed-flow fan.

The motor 40m is fixed to the inner wall 27a of the fan attachment portion 27 via a support member (not shown). The motor 40m is electrically connected to an ECU 50.

The ECU 50 includes a CPU, a ROM, a RAM, a memory device, an input/output port, and the like. The ECU 50 is electrically connected with various sensors such as an accelerator opening sensor 51, an atmospheric pressure sensor 52, an engine rotation sensor 53, and a supercharging pressure sensor 54.

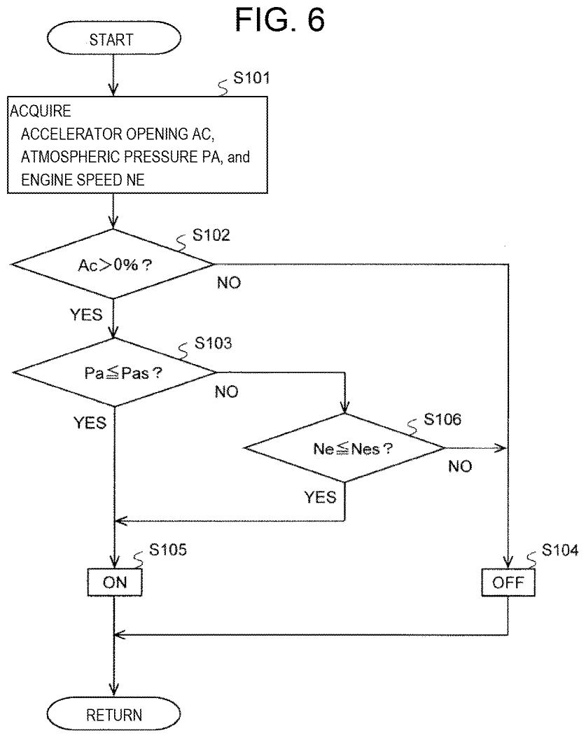

FIG. 6 is a flowchart showing the control of the ECU 50 according to the present embodiment.

For example, while the ignition switch (not shown) of the vehicle 1 is ON, the ECU 50 repeatedly executes the control flow in FIG. 6 every predetermined calculation period (for example, 10 ms).

In step S101, the ECU 50 acquires the detection value Ac of the accelerator opening sensor 51, the detection value Pa of the atmospheric pressure sensor 52, and the detection value Ne of the engine rotation sensor 53.

In step S102, the ECU 50 determines whether the first condition (Ac>0%) in which the detection value Ac of the accelerator opening sensor 51 is larger than a threshold value (0% in this case) is satisfied. When it is determined in step S102 that the first condition (Ac>0%) is satisfied (YES), the ECU 50 proceeds to step S103 and determines whether or not the second condition (Pa≤Pas) in which the detection value Pa of the atmospheric pressure sensor 52 is equal to or less than the threshold Pas.

On the other hand, when it is determined in step S102 that the first condition (Ac>0%) is not satisfied (NO), the ECU 50 proceeds to step S104, executes control (OFF) that does not operate the fan 40 by stopping the motor 40m, and returns.

When it is determined in step S103 that the second condition (Pa≤Pas) is satisfied (YES), the ECU 50 proceeds to step S105, executes control (ON) for operating the fan 40 by driving the motor 40m, and returns.

When it is determined in step S103 that the second condition (Pa≤Pas) is not satisfied (NO), the ECU 50 proceeds to step S106 and determines whether or not the third condition (Ne≤Nes) in which the detection value Ne of the engine rotation sensor 53 is equal to or less than the threshold Nes is satisfied. When it is determined in step S106 that the third condition (Ne≤Nes) is satisfied (YES), the ECU 50 proceeds to step S105, executes control (ON) for operating the fan 40 by driving the motor 40m, and returns.

On the other hand, when it is determined in step S106 that the third condition (Ne≤Nes) is not satisfied (NO), the ECU 50 proceeds to step S104 to execute control (OFF) that does not operate the fan 40 by stopping the motor 40m, and returns.

In this way, the ECU 50 of the present embodiment operates the fan 40 when the first condition (Ac>0%) is satisfied and at least one of the second condition (Pa≤Pas) and the third condition (Ne≤Nes) is satisfied. On the other hand, when the first condition is not satisfied or at least one of the second condition and the third condition is not satisfied, the ECU 50 does not operate the fan 40.

Next, the operation and effect of the intake increasing device 100 according to the present embodiment will be described with reference to FIGS. 1 to 6.

In the engine 10, basically, an amount of intake air F1 required for combustion is introduced into the combustion chamber of the engine body 11 according to a required output such as acceleration or deceleration of the vehicle 1.

Specifically, during operation of the engine 10, the intake air F1 is introduced into the cover member 60 from the atmosphere, sequentially passes through the tubular body 20, the intake duct 15, the air cleaner 14, the intake pipe 13, and the turbocharger compressor, the intake pipe 13 and the intake manifold 12, and is introduced into the combustion chamber.

Further, the intake air F1 is supercharged by the turbocharger compressor, and is thus fed into the combustion chamber in a large amount. As a result, the engine output can be increased.

In the present embodiment, the ECU 50 executes control to operate the fan 40 when the first condition (Ac>0%) is satisfied and at least one of the second condition (Pa≤Pas) and the third condition (Ne≤Nes) is satisfied. When the fan 40 is operated, in the tubular body 20, the air F2 is sent to the ejection port 30 and is ejected from the ejection port 30 toward the intake downstream side.

As shown in FIGS. 4 and 5, the ejected air F2 flows from the downstream cutting end portion 33 of the inner wall portion 24 to the intake downstream side along the inner circumferential surface 21 by the Coanda effect, and draws the intake air F1 passing through the radially inner side of the inner wall portion 24. By this operation, the intake air F1 is accelerated, so that the intake air F1 can be increased.

In particular, the reduced diameter portion 20a of the tubular body 20 is reduced in diameter from the intake inlet 20in to the ejection port 30 in a round cross-sectional shape having a predetermined radius of curvature R. Thus, the intake air F1 can be smoothly introduced into the intake inlet 20in along the cross-sectional shape.

The curved surface portion 23 having a round cross-sectional shape facing the space 31 is formed at the upstream end portion of the tubular body 20, and the ejection port 30 is directed toward the intake downstream side. Thus, the air F2 introduced into the space 31 from the fan 40 can be smoothly changed in the direction along the curved surface portion 23, and the air F2 can be ejected from the ejection port 30 in a desired direction in the intake air downstream direction.

In addition, since the ejection port 30 is formed in a slit shape over the entire periphery of the inner wall portion 24, the air F2 can be uniformly ejected in the entire periphery. Further, since the ejection port 30 is formed in a nozzle shape, the air F2 can be accelerated and ejected.

In this way, with the above configuration, the effect of flowing the intake air F1 along the inner circumferential surface 21 can be increased to the maximum, and the intake air F1 can be further increased. The ejection port 30 may not be formed over the entire periphery of the inner wall portion 24.

Although not shown, a vehicle to which the intake increasing device 100 is not applied will be discussed as a comparative example.

In this case, for example, since the oxygen concentration in the air is low at places where the atmospheric pressure is low, such as a highland, there is a possibility that an amount of intake air required for combustion cannot be secured even if supercharging is performed by a turbocharger and the like. For this reason, for example, compared to a place where the oxygen concentration in the air is higher than that of a highland and the like, the engine output is reduced, and the fuel efficiency may be deteriorated.

In addition, for example, there is a possibility that a difference in output may occur due to a difference in the use environment of the engine, such as a decrease in the acceleration performance of the vehicle at a highland compared to a lowland. Therefore, the driving performance of the vehicle may be deteriorated.

In particular, in an operating state in which the engine speed is low, the turbocharger may not operate efficiently. Therefore, there is a possibility that a problem such as deterioration of the startability may occur due to engine output reduction.

As means for solving these problems, it is conceivable to use a turbocharger that is set to operate efficiently at places where the atmospheric pressure is low or in an operation state in which the engine rotation speed is low (hereinafter, referred to as an “intake shortage state”). However, in this turbocharger, when the engine is not in the intake shortage state, the supercharging efficiency is reduced, and the engine output may be reduced during running other than a highland or starting time.

The intake increasing device 100 of the present embodiment increases the intake air F1 when the detection value Pa of the atmospheric pressure sensor 52 is equal to or less than the threshold value Pas. Thus, in a place where the atmospheric pressure is low, the engine output can be increased, and as a result, the fuel efficiency can be improved. In addition, since the output difference due to the use environment of the engine 10 can be reduced, the operability of the vehicle 1 can be improved.

The intake increasing device 100 increases the intake air F1 when the detection value Ne of the engine rotation sensor 53 is equal to or less than the threshold Nes. Thus, in the low rotation range of the engine in which the turbocharger does not operate efficiently, the increased intake air F1 is introduced into the compressor to increase the supercharging pressure and the decrease in the engine output can be suppressed. Then, the startability of the vehicle 1 can be improved.

Further, according to the intake air increasing device 100, when the intake air is in the intake shortage state, the supercharging pressure of the turbocharger is increased by increasing the intake air F1, and when the intake air is not in the intake shortage state, the supercharging pressure of the turbocharger can be efficiently increased only with the turbocharger without increasing the intake air F1.

As described above, in the present embodiment, regardless of the use environment and the operating state of the engine 10, a required amount of intake air can be ensured and output reduction can be suppressed, and the fuel efficiency, the startability, and the like can be improved.

In addition, in the present embodiment, the following operations and effects exist in addition to the above.

Although not shown, for example, it is assumed that an ejecting nozzle or a fan for ejecting air to the intake downstream side is disposed radially inward of the inner circumferential surface of the tubular body. In the case, an ejecting nozzle and the like may be an obstacle to intake air, which may hinder an increase in intake air.

In contrast, in the present embodiment, since the ejection port 30 is provided on the inner circumferential surface 21 of the tubular body 20 and there is no obstacle on the radially inner side of the inner circumferential surface 21, the intake air F1 can be efficiently increased without generating the intake resistance.

Although not shown, for example, when the tubular body 20 is formed in a circular cross section, for example, when the gap between the rear surface of the cab and the bodywork is small, only a tubular body having a small diameter can be used. Therefore, the passage area in the tubular body is reduced, and the intake air amount is limited.

In contrast, in the present embodiment, as shown in FIGS. 1 and 2, the tubular body 20 is formed in a flat cross section and is disposed along the rear surface 2a of the cab 2 such that the longitudinal direction of the cross section thereof coincides with the vehicle width direction. Therefore, even when the gap between the rear surface 2a of the cab 2 and the bodywork 4 is small, the passage area in the tubular body 20 can be increased, which is advantageous in increasing the intake air amount.

In particular, as shown in FIG. 1, there is a case where there is little gap between the center portion of the rear surface 2a of the cab 2 protruding rearward and the bodywork 4 in the cab-over type truck. A recessed portion C having a short front-rear length may be formed on the right side of the central portion of the rear surface 2a.

In the present embodiment, the tubular body 20 is formed in a flat cross section, and is disposed in the recessed portion C together with the cover member 60. Therefore, the tubular body 20 having a large passage area can be disposed.

On the other hand, in the control of the present embodiment, the ECU 50 determines that the driver has an intention to accelerate when the first condition (Ac>0%) is satisfied, and operates the fan 40 when the second condition (Pa≤Pas) or the third condition (Ne≤Nes) is satisfied. When the first condition (Ac>0%) is not satisfied, the ECU 50 does not operate the fan 40 as the driver does not intend to accelerate. Therefore, the fan 40 can be efficiently operated by determining whether or not the driver has an intention to accelerate.

### (2) Second Embodiment

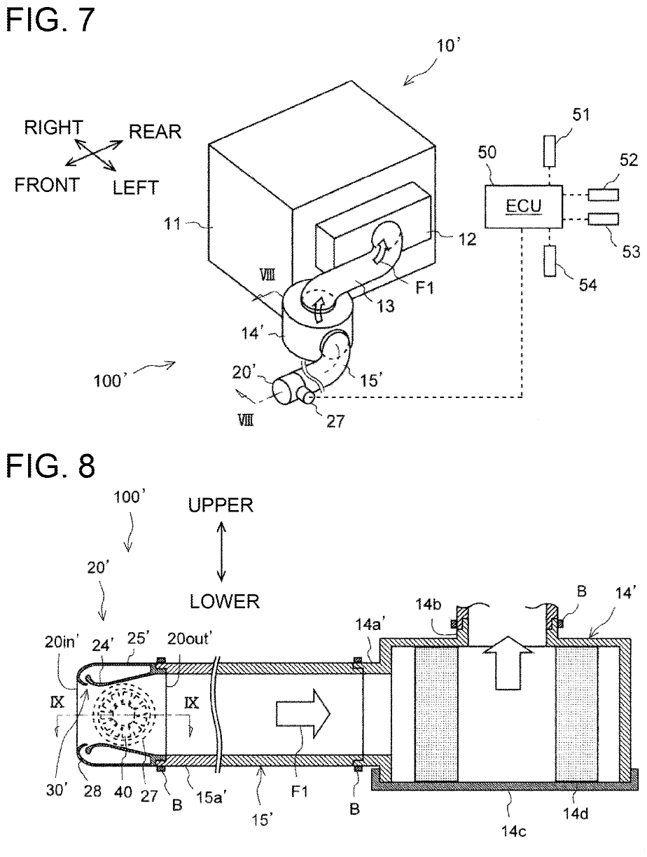

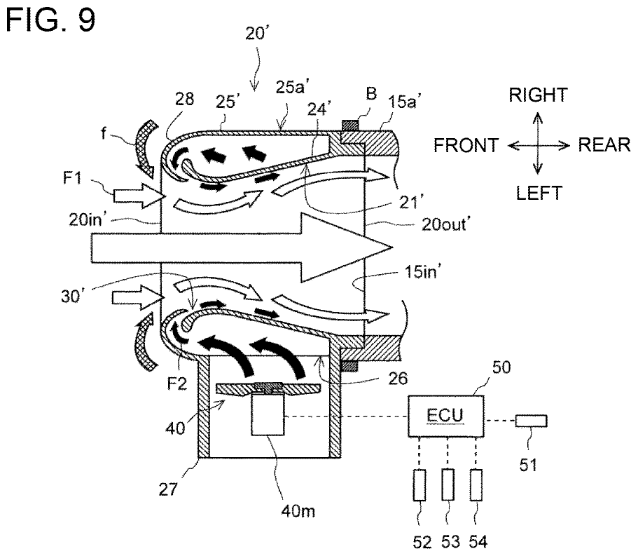

FIG. 7 is a schematic perspective view showing an overall configuration of an intake increasing device 100′ according to a second embodiment of the present disclosure. Further, FIG. 8 is a cross-sectional view taken along line VIII-VIII in FIG. 7, and FIG. 9 is a cross-sectional view taken along line IX-IX in FIG. 8. In the following description, the same components as those of the first embodiment are denoted by the same reference numerals, and the components corresponding to those in the first embodiment are denoted by the reference numerals with the symbol “′”, and detailed description thereof will be omitted.

As shown in FIGS. 7 and 8, in the second embodiment, the air cleaner 14′ is disposed on the left front side of the engine body 11, and the intake duct 15′ is disposed so as to extend forward from the inlet portion 14a′ of the air cleaner 14′. The inlet portion 15a′ of the intake duct 15′ is formed in a circular cross section and opens forward.

The tubular body 20′ includes a circular cross section and is connected to an inlet 15a′ of the intake duct 15′. The tubular body 20′ is disposed below the left front portion of the cab 2, and the intake inlet 20in′ is disposed so as to open forward. The intake outlet 20out′ is connected to the inlet 15in′ of the intake duct 15′.

The cover member 60 as in the first embodiment is not connected to the intake inlet 20in′ of the tubular body 20′. Therefore, as indicated by the shaded arrow in FIG. 9, the intake air f can be introduced directly into the intake inlet 20in′ from the outside in the radial direction of the tubular body 20′.

In particular, at the upstream end of the tubular body 20′, as shown in FIG. 9, an end surface 28 having a round cross-sectional shape is formed from the intake inlet 20in′ to the outer peripheral surface 25a′ of the outer wall portion 25′. Accordingly, the intake air f can be smoothly introduced from the outside along the end surface 28.

The intake air f introduced into the intake inlet 20in′ is ejected from the ejection port 30′ and is attracted to the air F2 flowing along the inner circumferential surface 21′ of the inner wall portion 24′, and is accelerated together with the intake air F1 introduced from the front. As a result, the intake air increasing device 100′ of the second embodiment can obtain a larger amount of intake air than that of the first embodiment.

### (3) Third Embodiment

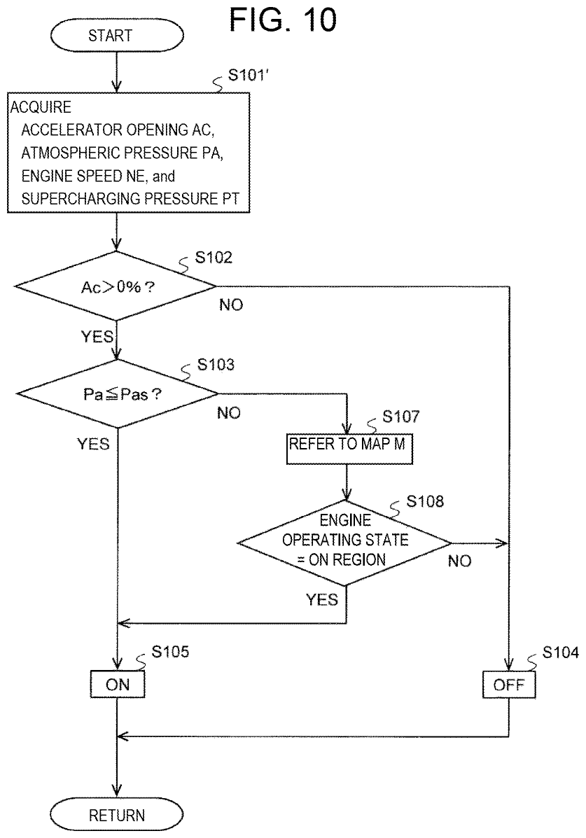

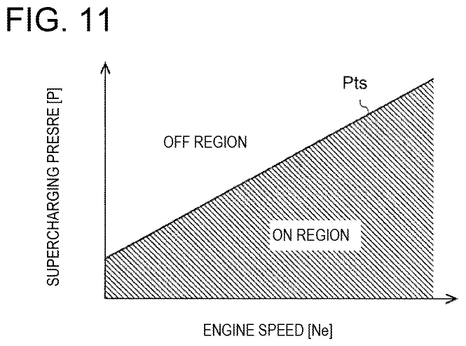

FIG. 10 is a flowchart showing the control of the ECU 50 according to a third embodiment of the present disclosure. Further, FIG. 11 is a map M showing a relationship between the engine speed and the supercharging pressure. The third embodiment can be applied to at least one of the above-described first and second embodiments.

As shown in FIG. 10, the ECU 50 of the third embodiment refers to the map M and determines whether or not a fourth condition (engine operating state=ON region) in which the engine operating state is a predetermined supercharging insufficient state is satisfied, instead of the third condition (Ne≤Nes) described in the first embodiment.

Here, the “engine operating state” means an operating state defined based on the detection value Ne of the engine rotation sensor 53 and the detection value Pt of the supercharging pressure sensor 54. Further, the “predetermined supercharging insufficient state” means an operation state in which the supercharging pressure of the turbocharger compressor is insufficient.

As shown in FIG. 11, the map M defines the relationship between the engine speed and the threshold value Pts of the supercharging pressure corresponding to the engine speed.

More specifically, in the map M, a region below the threshold value Pts is in supercharging insufficient state, and is set to an ON region where the fan 40 is operated. On the other hand, the region that is equal to or more than the threshold value Pts is not in a supercharging insufficient state, and is set to an OFF region in which the fan 40 is not operated.

By referring to the map M, the ECU 50 determines that the detection value Pt of the supercharging pressure sensor 54 is in the ON region when the detection value Pt of the supercharging pressure sensor 54 is less than the threshold value Pts of the supercharging pressure corresponding to the detection value Ne of the engine rotation sensor 53. On the contrary, when the detection value Pt of the supercharging pressure sensor 54 is equal to or more than the threshold value Pts of the supercharging pressure corresponding to the detection value Ne of the engine rotation sensor 53, it is determined that the detection value Pt of the supercharging pressure sensor 54 is not in the ON region.

Specifically, as shown in FIG. 10, in step S101′, the ECU 50 acquires the detection value Pt of the supercharging pressure sensor 54 together with the detection value Ac of the accelerator opening sensor 51, the detection value Pa of the atmospheric pressure sensor 52, and the detection value Ne of the engine rotation sensor 53.

When it is determined in step S103 that the second condition (Pa≤Pas) is not satisfied (NO), the ECU 50 proceeds to step S107 and refers to the map M. Then, the ECU 50 proceeds to step S108 to determine whether or not the fourth condition (engine operating state=ON region) is satisfied.

When it is determined in step S108 that the fourth condition (engine operating state=ON region) is satisfied (YES), the ECU 50 proceeds to step S105 to execute control (ON) for operating the fan 40 by driving the motor 40m, and returns.

On the other hand, when it is determined in step S108 that the fourth condition (engine operating state=ON region) is not satisfied (NO), the ECU 50 proceeds to step S104 to execute control (OFF) that does not operate the fan 40 by stopping the motor 40m, and returns.

According to the above control, even when the engine speed is low, the ECU 50 cannot operate the fan 40 when the supercharging pressure required for combustion is obtained. In contrast, even when the engine speed is high, the fan 40 can be operated when the supercharging pressure required for combustion is not obtained.

Therefore, since the intake air F1 can be increased in consideration of not only the engine speed Ne but also the supercharging pressure Pt, output reduction can be suppressed with higher accuracy.

Additionally, the present disclosure is not limited to the embodiments described above, and can be appropriately modified and implemented without departing from the spirit of the present disclosure. Although not shown, for example, the above-described embodiments can be modified as follows.

### First Modified Embodiment

With regard to the control of the ECU 50, the first to fourth conditions may be combined optionally.

For example, the ECU 50 may determine only the first condition without determining the second, third or fourth conditions, and operate the fan 40 when the first condition is satisfied (Ac>0%). According to this control, when the accelerator opening Ac is larger than 0%, the intake air F1 is always increased to improve the engine output.

Further, the fan 40 may be operated when the third condition (Ne≤Nes) or the fourth condition (engine operating state=ON region) is satisfied without providing the second condition (Pa≤Pas). Further, the fan 40 may be operated when the second condition (Pa≤Pas) is satisfied without providing the third condition (Ne≤Nes) or the fourth condition (engine operating state=ON region). Further, the fan 40 may be operated constantly during operation of the engine or during running of the vehicle without providing any conditions.

### Second Modified Embodiment

The ECU 50 may control the rotation speed of the fan 40 corresponding to the detection value Ac of the atmospheric pressure sensor 52 and the detection value Ne of the engine rotation sensor 53.

For example, the ECU 50 may control the rotation speed of the fan 40 to be higher as the detection value Ac of the atmospheric pressure sensor 52 is lower with reference to a predetermined map defining the relationship between the atmospheric pressure and the rotation speed of the fan 40.

The ECU 50 may control the rotation speed of the fan 40 to be higher as the detection value Ne of the engine rotation sensor 53 is lower with reference to the predetermined map defining the relationship between the engine speed and the rotation speed of the fan 40.

Further, the ECU 50 may control the rotation speed of the fan 40 to be higher as the atmospheric pressure and the engine speed are lower, for example, with reference to the predetermined map defining the relationship among the atmospheric pressure, the engine speed, and the rotation speed of the fan 40.

According to these controls, the intake air F1 can be increased with higher accuracy corresponding to the use environment and the operating state of the engine.

### Third Modified Embodiment

In the first embodiment, the inlet portion 15a of the intake duct 15′, the tubular body 20, and the cover member 60 have flat cross sections, and in the second embodiment, the inlet portion 15a′ of the intake duct 15′ and the tubular body 20′ have circular cross sections, but these cross-sectional shapes may be optional. That is, these cross-sectional shapes can be freely changed, for example, corresponding to the layout of the vehicle 1.

### Fourth Modified Embodiment

In the tubular body 20, 20′, the opening portion 26 and the fan attachment portion 27 may have any shape or orientation. For example, the opening portion 26 may be formed on the right side surface of the outer wall portion 25, and the fan attachment portion 27 may be provided so as to protrude rightward.

In the fan attachment portion 27, the direction of the air inlet 27in may be optional. For example, in FIG. 2, the air inlet 27in may be opened downward at the position of the left end portion of the fan attachment portion 27.

This application is based on the Japanese Patent Application No. 2017-074595 filed on Apr. 4, 2017, the contents of which are incorporated herein as reference.

### INDUSTRIAL APPLICABILITY

The intake increasing device of the present disclosure is useful in that a required amount of intake air can be ensured, and the output reduction can be suppressed regardless of the use environment and the operating state of the engine.

### REFERENCE SIGNS LIST

10 Engine
20 Tubular Body (Wall Portion)
20in Intake Inlet
20out Intake Outlet
21 Inner circumferential surface
30 Ejection port
40 Fan
50 ECU (Control Unit)
100 Intake Increasing Device
F1 Intake Air
F2 Air

1. An intake increasing device for increasing intake air of an engine,
comprising:
a cylindrical wall part that includes an intake inlet and an intake outlet and guides intake air from the intake inlet to the intake outlet;
a ejection port that is provided in the wall portion and ejects air flowing toward an intake downstream side along an inner circumferential surface of the wall portion; and
a fan that sends air to the ejection port.

2. The intake increasing device according to claim 1, wherein
the cross-sectional shape of the inner circumferential surface of the wall portion approximates a cross-sectional shape of the blade upper surface.

3. The intake increasing device according to claim 1,
wherein
the inner circumferential surface of the wall portion includes a reduced diameter portion which is gradually reduced in diameter from the intake inlet to a round cross-sectional shape, and an enlarged diameter portion which smoothly connects to the reduced diameter portion and gradually increases in diameter, and
the ejection port is positioned at the reduced diameter portion and is directed toward the intake downstream side.

4. The intake increasing device according to claim 1,
wherein
the ejection port extends in a peripheral direction of the wall portion.

5. The intake increasing device according to claim 1,
wherein
the engine is mounted on a vehicle,
the intake increasing device includes a control device for controlling the fan, and an accelerator opening sensor configured to detect an accelerator opening, and
the control device operates the fan when a first condition that a detection value of the accelerator opening sensor is larger than a first threshold value is satisfied.

6. The intake increasing device according to claim 5, further comprising:
an atmospheric pressure sensor that detects atmospheric pressure; and
an engine rotation sensor that detects the engine speed,
wherein the control device operates the fan when the first condition is satisfied and at least one of a second condition that a detection value of the atmospheric pressure sensor is equal to or less than a second threshold value and a third condition that the detection value of the engine rotation sensor is equal to or less than a third threshold value is satisfied.

7. The intake increasing device according to claim 5, wherein
the engine includes a supercharger,
the intake increasing device includes an atmospheric pressure sensor that detects atmospheric pressure, an engine rotation sensor that detects an engine speed, and an supercharging pressure sensor that detects the supercharging pressure,
the control device operates the fan when the first condition is satisfied, and at least one of a second condition that a detection value of the atmospheric pressure sensor is equal to or less than a second threshold value, and a fourth condition that engine operating state defined based on a detection value of the engine rotation sensor and a detection value of the supercharging pressure sensor is a predetermined supercharging insufficient state is satisfied.

8. The intake increasing device according to claim 1,
wherein
the engine is mounted on a vehicle including a cab, and
the wall portion is formed in a flat cross section, and is disposed along a rear surface of the cab such that the intake inlet opens upward, the intake outlet opens downward, and the longitudinal direction of the cross section thereof coincides with the vehicle width direction.

9. The intake increasing device according to claim 8, wherein
the engine includes an air cleaner and an intake duct connected to an inlet portion of the air cleaner,
the wall portion is connected to the inlet portion of the intake duct,
the inlet portion of the intake duct is formed in a flat cross section, and
the intake outlet is connected to an inlet of the intake duct.
